(19) United States
(12) Patent Application Publication
(10) Pub. No.: US 2016/0347581 A1
(43) Pub. Date: Dec. 1, 2016

(54) APPARATUS FOR MOVING ASSEMBLY

(71) Applicants: Clayton Quinn, Edmonton (CA); James Douglas Hildebrand, Sturgeon County (CA)

(72) Inventors: Clayton Quinn, Edmonton (CA); James Douglas Hildebrand, Sturgeon County (CA)

(21) Appl. No.: 14/720,864

(22) Filed: May 25, 2015

(51) Int. Cl. B66C 1/12; B60D 1/58

(52) U.S. Cl. CPC B66C 1/12; B60D 1/58

(57) ABSTRACT

An apparatus is for a moving assembly. The moving assembly is configured to move a load via a sling assembly operatively connectable to the load. The sling assembly has a first sling connection portion and a second sling connection portion. The apparatus includes a sling tensioning assembly having a first connection portion and a second connection portion spaced apart from the first connection portion. The sling tensioning assembly is configured, in use, to remove the slack from the sling assembly. A connector assembly is configured to connect the first connection portion of the sling tensioning assembly to the first sling connection portion of the sling assembly. The connector assembly is also configured to connect the second connection portion of the sling tensioning assembly to any one of the second sling connection portion of the sling assembly and the load.

### TECHNICAL FIELD

This document relates to the technical field of (and is not limited to) an apparatus for a moving assembly configured to move (such as, lift) a load via a sling assembly.

### BACKGROUND

Moving assemblies (such as tow trucks) or lifting assemblies, such as a crane, are machines equipped with a hoist, wire ropes or chains (a sling), and sheaves configured to move (lift and/or lower) a load (materials) and to move them horizontally. The lifting assembly is used for lifting heavy objects and transporting the objects to other places. The lifting assembly is configured to lift (lower, move) loads beyond the normal capability of a human. The lifting assembly may be used for the loading and unloading of freight, for the movement of construction materials, and/or for the assembling of heavy equipment, etc.

### SUMMARY

It will be appreciated that there exists a need to mitigate (at least in part) at least one problem associated with existing moving assemblies such as, lifting assemblies, etc., and also called the existing technology. After much study of the known systems and methods with experimentation, an understanding of the problem and its solution has been identified and is articulated as follows:

The existing technology suffers from unwanted formation of potential pinch points (or a line of fire) along the sling, and may lead to unsafe operation of the moving assembly (for moving a load), such as a lifting assembly (for lifting a load), etc.

To mitigate, at least in part, at least one problem associated with existing technology, there is provided (in accordance with a first major aspect) an apparatus. The apparatus is for a moving assembly. The moving assembly is configured to move a load via a sling assembly operatively connectable to the load. The sling assembly has a first sling connection portion and a second sling connection portion. The apparatus includes a sling tensioning assembly. The sling tensioning assembly has a first connection portion and also has a second connection portion. The second connection portion is spaced apart from the first connection portion. The sling tensioning assembly is configured, in use, to remove the slack from the sling assembly. A connector assembly is configured to connect the first connection portion of the sling tensioning assembly to the first sling connection portion of the sling assembly. The connector assembly is also configured to connect the second connection portion of the sling tensioning assembly to any one of the second sling connection portion of the sling assembly and the load.

To mitigate, at least in part, at least one problem associated with existing technology, there is provided (in accordance with a second major aspect) an apparatus. The apparatus is for a load. The apparatus includes a sling assembly operatively connectable to the load. The sling assembly has a first sling connection portion and a second sling connection portion. The second sling connection portion is spaced apart from the first sling connection portion. A moving assembly is configured to move the load via the sling assembly. A sling tensioning assembly has a first connection portion and also has a second connection portion. The second connection portion is spaced apart from the first connection portion. The sling tensioning assembly is configured, in use, to remove the slack from the sling assembly. A connector assembly is configured to connect the first connection portion of the sling tensioning assembly to the first sling connection portion of the sling assembly. The connector assembly is also configured to connect the second connection portion of the sling tensioning assembly to any one of the second sling connection portion of the sling assembly and the load.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 and FIG. 2 (SHEET 1 of 6 SHEETS) depict side views of embodiments of a moving assembly and a load; and

FIG. 3, FIG. 4, FIG. 5, FIG. 6, FIG. 7, FIG. 8A and FIG. 8B (SHEETS 2 to 6 of 6 SHEETS) depict side views of embodiments of an apparatus for the moving assembly, the load and the sling assembly of FIG. 2.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 sling tensioning assembly
104 first connection portion
106 second connection portion
108 connector assembly
110 elastically deformable member
112 first connector
114 second connector
116 articulation assembly
900 moving assembly
901 movable-node point
902 load
904 sling assembly
906 first sling connection portion
908 second sling connection portion
910 working surface
912 sling hook-up point
914 lug assembly
916 shackle assembly
918 clamp device

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

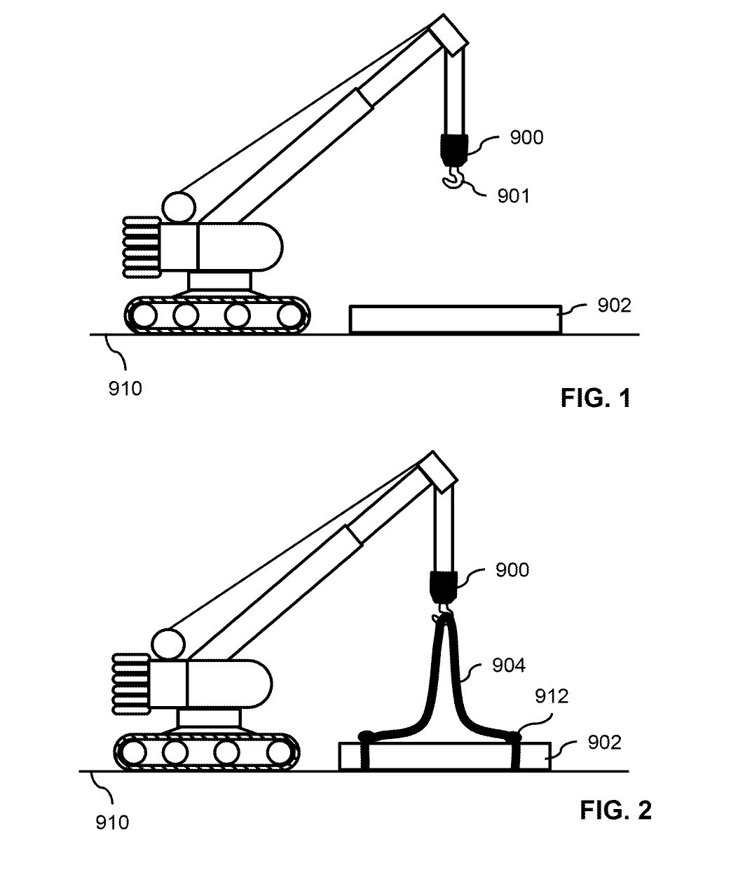

FIG. 1 and FIG. 2 depict side views of embodiments of a moving assembly 900 and a load 902.

The moving assembly 900 is configured to move (lift, etc.) the load 902 once the moving assembly 900 is operatively coupled (connected) to the load 902, and the moving assembly 900 is operated to do just so. The moving assembly 900 is configured to support the load 902 while moving (such as, lifting, moving or lowering, etc.) the load 902 above a working surface 910. It will be appreciated that the definition of moving includes lifting, lowering, moving, etc. By way of a specific embodiment, the moving assembly 900 may include a crane, a boom truck or an overhead crane, a chain fall, a rigged-lifting system, etc., and any equivalent thereof. The moving assembly 900 includes a movable-node point 901. The movable-node point 901 may include a lifting hook, etc., and any equivalent thereof. The movable-node point 901 is configured to move (lift or lower) the sling assembly 904.

The moving assembly 900 may include a lifting assembly, a lateral-moving assembly, etc., and any equivalent thereof. The moving assembly 900 may be configured to move the load 902 in any desired direction.

In accordance with the embodiment as depicted in FIG. 2, the load 902 includes a sling hook-up point 912. The sling hook-up point 912 is located at each position in which the sling assembly 904 is to make an operative attachment to the load 902. The sling assembly 904 may include, for instance, a cable, a wire, a rope, a chain, etc., and any equivalent thereof (in any number of instances thereof). The sling assembly 904 is configured to extend from the load 902 to the movable-node point 901 of the moving assembly 900. The sling assembly 904 is configured to be operatively connectable to the sling hook-up point 912 of the load 902 and to the movable-node point 901 of the moving assembly 900. In operation, the moving assembly 900 is configured to lift (move) the load 902 via the sling assembly 904.

It will be appreciated that there may be many instances of the sling hook-up point 912 as may be required to lift the load 902. For the case where multiple instances of the sling hook-up point 912 are deployed, the moving assembly 900 does not have to keep resetting (in order to move the load 902). The sling tensioning assembly 102 is configured to hold in use) the sling assembly 904 in place and to ensure a smooth movement of the sling assembly 904. The sling tensioning assembly 102 is configured, in use, to remove the slack from the sling assembly 904.

Referring to the embodiment as depicted in FIG. 1, the load 902 rests on the working surface 910 (such as, the ground surface).

Referring to the embodiment as depicted in FIG. 2, the movable-node point 901 (the hook) is connected to the load 902 via the sling assembly 904. The sling assembly 904 is free to move around because there is slack in the sling assembly 904. As the moving assembly 900 (depicted as the crane) pulls the sling assembly 904 upwardly, the length of the sling assembly 904 changes and may inadvertently result in an uneven orientation of the load 902 (as the load 902 is lifted away from (moved relative to) the working surface 910). Once the load 902 is lifted (moved) with an uneven orientation, the moving assembly 900 may attempt to reposition any one of the sling assembly 904 and/or the load 902, thereby potentially placing a worker (located on the working surface 910 proximate to the load 902) in a dangerous position and/or causing inadvertent damage to the load 902.

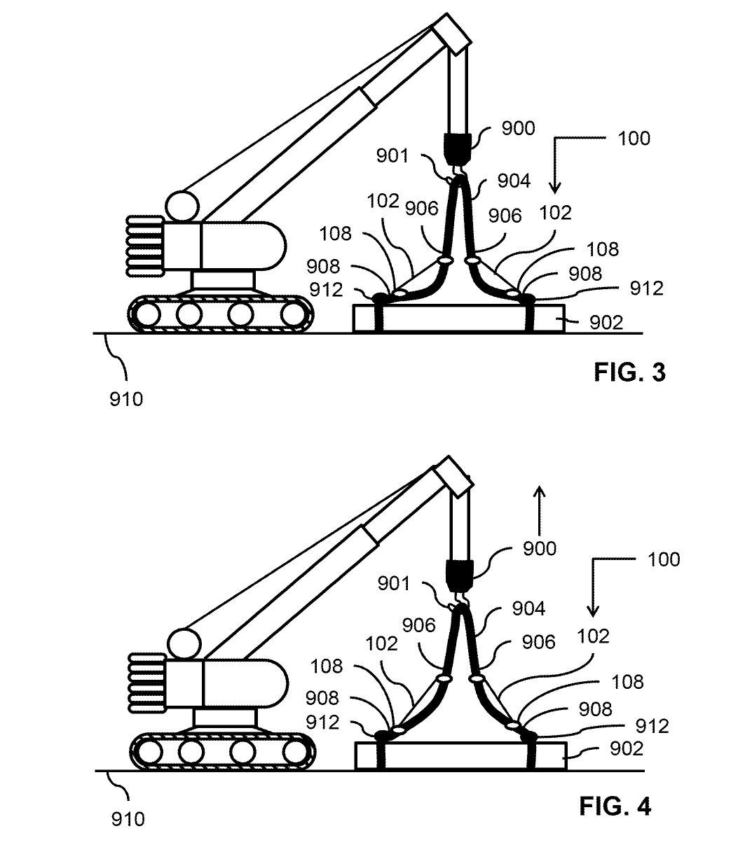

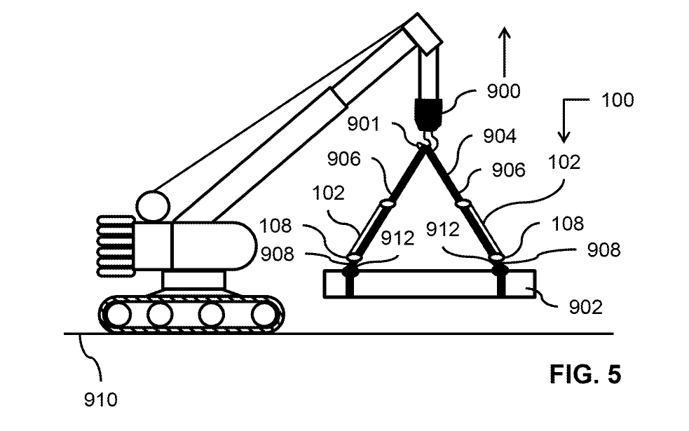

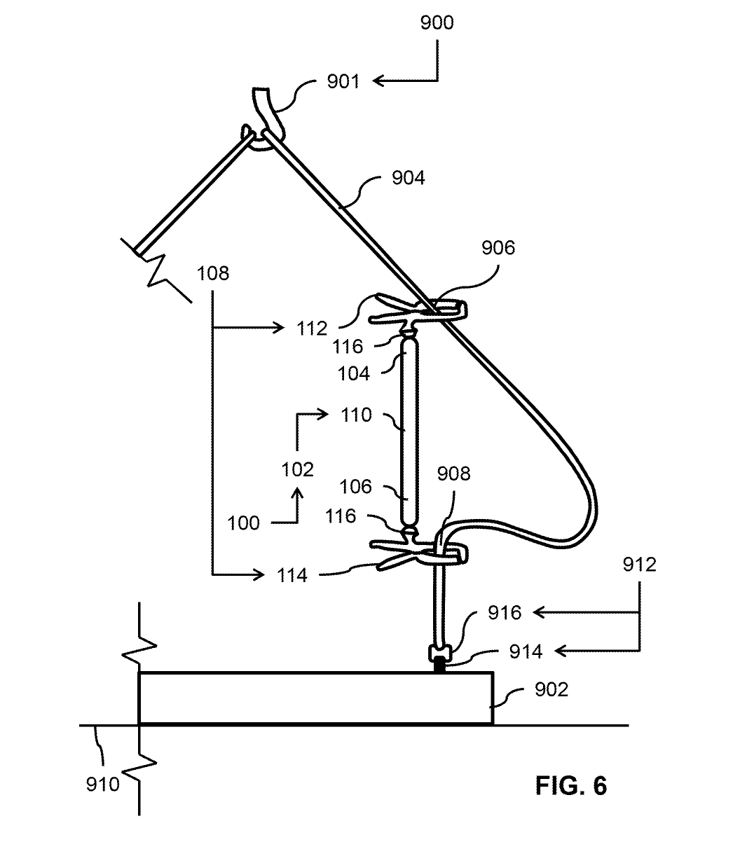

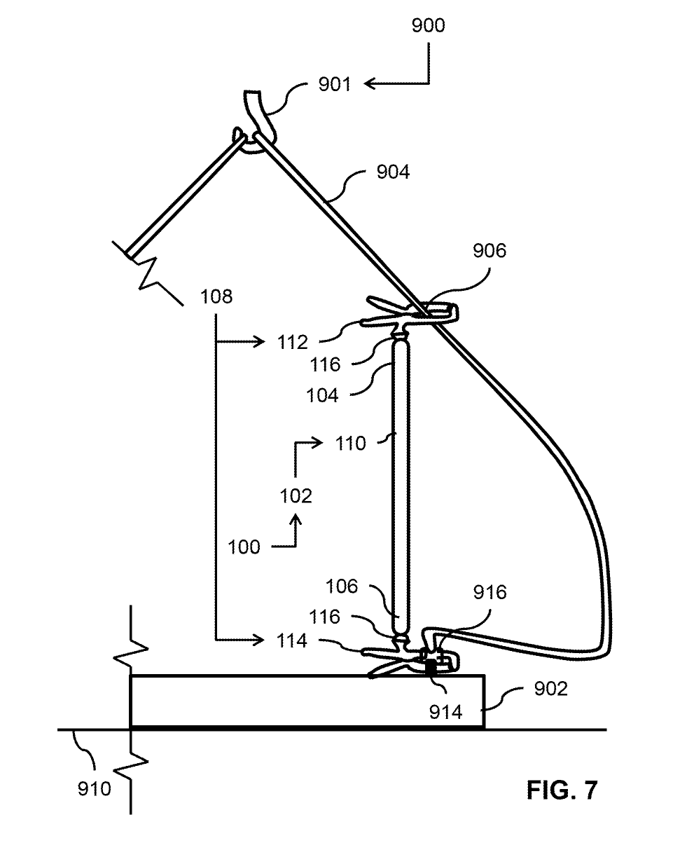

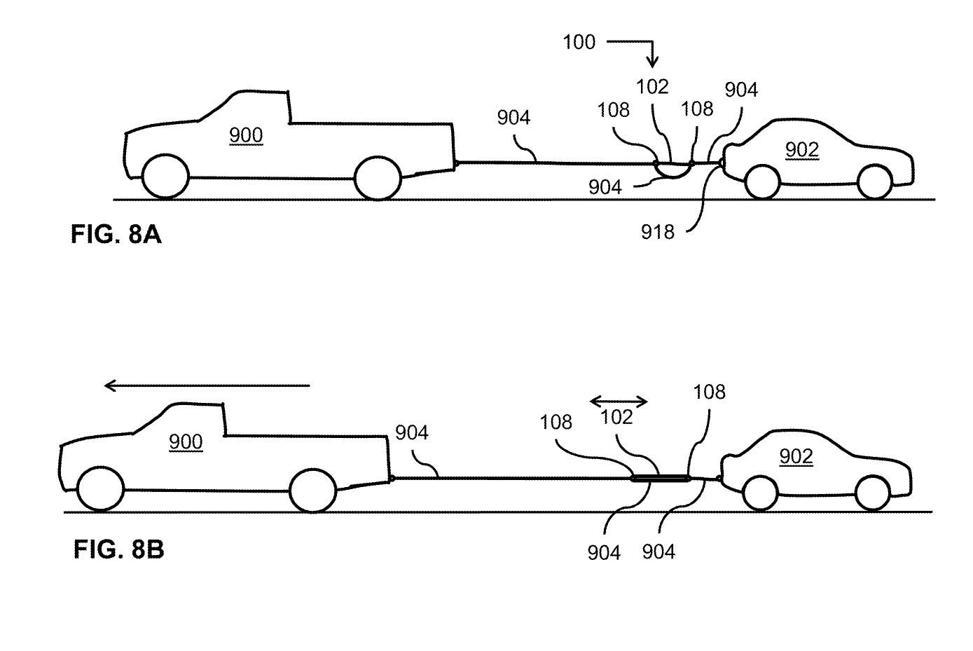

FIGS. 3, 4, 5, 6 and 7 depict side views of embodiments of an apparatus 100 for the moving assembly 900, the load 902 and the sling assembly 904 of FIG. 2.

Referring to the embodiments as depicted in FIGS. 3, 4 and 5, in accordance with a first major embodiment, the apparatus 100 is for the moving assembly 900 that is configured to lift (move) the load 902 via the sling assembly 904. The sling assembly 904 is operatively connectable to the load 902. The sling assembly 904 has the first sling connection portion 906 and the second sling connection portion 908. The second sling connection portion 908 is spaced apart from the first sling connection portion 906. It will be appreciated that the apparatus 100 does not include the moving assembly 900, the load 902 and the sling assembly 904.

In accordance with the first major embodiment, the apparatus 100 includes (and is not limited to) a synergistic combination of the sling tensioning assembly 102 and the connector assembly 108. The sling tensioning assembly 102 has a first connection portion 104. The sling tensioning assembly 102 also has a second connection portion 106 that is spaced apart from the first connection portion 104. The sling tensioning assembly 102 is configured, in use, to remove the slack from the sling assembly 904. The connector assembly 108 is configured to connect the first connection portion 104 of the sling tensioning assembly 102 to the first sling connection portion 906 of the sling assembly 904. The connector assembly 108 is also configured to connect the second connection portion 106 of the sling tensioning assembly 102 to any one of the second sling connection portion 908 of the sling assembly 904 and the load 902.

A technical effect of the sling tensioning assembly 102 is that, in use, the sling tensioning assembly 102 reduces (preferably eliminates) the formation of potential pinch points (or a line of fire) along the sling assembly 904, and thereby the sling assembly 904 improves (at least in part) user safety for the case where the sling tensioning assembly 102 is used in the process of lifting (moving) the load 902.

FIG. 3, FIG. 4, FIG. 5, FIG. 6, FIG. 7, FIG. 8A and FIG. 8B depict side views of embodiments of an apparatus 100 for the moving assembly 900, the load 902 and the sling assembly 904 of FIG. 2.

Referring to the embodiment as depicted in FIG. 3, the apparatus 100 is operatively attached to the sling assembly 904. Preferably, the sling tensioning assembly 102 is operatively attached to the sling assembly 904 at each branch of the sling assembly 904 that is operatively connected to the load 902.

Referring to the embodiment as depicted in FIG. 4, the moving assembly 900 lifts (moves), in use, the sling assembly 904 (vertically) from the movable-node point 901 of the moving assembly 900. Generally, the sling tensioning assembly 102 (once installed) is configured to take out (remove), at least in part, slack from the sling assembly 904. Preferably, the sling tensioning assembly 102 (once installed) is configured to take out (remove), at least in part, slack from the sling assembly 904 before any one of the sling assembly 904 and the load 902 is lifted from (moved relative to) the working surface 910. In accordance with an option, the sling tensioning assembly 102 (once installed) is configured to stretch out (to lengthen), at least in part, once any one of the sling assembly 904 and the load 902 is lifted from (moved relative to) the working surface 910.

In accordance with a first option, the sling tensioning assembly 102 is installed to the sling assembly 904 (at spaced apart sling positions located on the sling assembly 904). In accordance with a second option, the sling tensioning assembly 102 is installed to a sling position on the sling assembly 904 and the sling hook-up point 912 (the point where the sling assembly 904 is attached to the load 902). The sling hook-up point 912 is operatively attached to the load 902, and the sling hook-up point 912 is configured to be attachable to the sling assembly 904.

Another technical advantage of the sling assembly 904 is that the sling assembly 904 (A) reduces (at least in part) a possibility that the sling assembly 904 may become loose (before the sling assembly 904 is lifted or is moved), and in this manner the sling assembly 904 may improve safety for the case where the load 902 is lifted (moved) by the action of the sling assembly 904 and the moving assembly 900, and/or (B) reduces, at least in part, the potential of risk of injury to users or workers.

In accordance with an option, the sling tensioning assembly 102 includes an elastically deformable member 110.

In accordance with a second major embodiment, the apparatus 100 is for the load 902. It will be appreciated that the apparatus 100 does not include the load 902. In accordance with the second major embodiment, the apparatus 100 includes (and is not limited to) a synergistic combination of the sling assembly 904, the moving assembly 900, the sling tensioning assembly 102, and the connector assembly 108.

Referring to the embodiment as depicted in FIGS. 3 and 4, one end of the sling tensioning assembly 102 is attached to a point located proximate to (just above or at) the sling hook-up point 912. Then, the sling assembly 904 that extends from the movable-node point 901 is pulled relatively tighter so that the opposite end (another end) of the sling tensioning assembly 102 may be attached (by the user) to the sling assembly 904 (at a position that is spaced apart from the sling hook-up point 912 and closer to the movable-node point 901). In this manner, the sling tensioning assembly 102 (once attached) is configured to reduce (preferably prevent) movement of the sling assembly 904 once the movable-node point 901 is lifted (moved) upwardly (as depicted in FIG. 4).

Referring to the embodiment as depicted in FIG. 5, as the movable-node point 901 hoists up, the workers located on the working surface 910 may remain positioned away from the load 902 and clear of any imminent danger simply because no worker is required to be positioned near the load 902 as the load 902 is lifted (moved) upwardly. The sling tensioning assembly 102 is configured to keep the sling assembly 904 relatively slack free (at least in part) as the sling assembly 904 is lifted in such a way that the load 902 is moved above (relative to) the working surface 910. As the load 902 is lifted (moved), the sling assembly 904 experiences fewer (preferably, no) pinch points or crush points, etc. As the movable-node point 901 hoists up (lifts or moves) the sling assembly 904, the sling assembly 904 becomes stretched, and the load 902 is lifted (moved) as evenly (for instance, for the case where the sling assembly 904 was initially set or affixed to the load 902 prior to lifting (moving) of the sling assembly 904).

Referring to the embodiments as depicted in FIGS. 6 and 7, the sling hook-up point 912 includes any one of a lug assembly 914 and a shackle assembly 916. The lug assembly 914 is configured to be affixed to the load 902. The shackle assembly 916 is configured to couple the lug assembly 914 to an end section of the sling assembly 904.

As the movable-node point 901 is lifted (moved), the sling tensioning assembly 102 is stretched (becomes lengthened), until the sling assembly 904 is tight.

In accordance with an embodiment, the elastically deformable member 110 includes, in accordance with an embodiment, a collection of at least one or more bungee cords (a bungee cord). The length of the elastically deformable member 110 may be (for instance) about 18 inches. The sling tensioning assembly 102 may be (for instance) waterproof (that is, has a waterproof casing). The elastically deformable member 110 may be, for instance, configured to be stretchable from about 18 inches to about three feet or about four feet.

In accordance with an embodiment, the connector assembly 108 includes a first connector 112 configured to be connectable to the first sling connection portion 906 of the sling assembly 904, and a second connector 114 configured to be connectable to any one of (A) the second sling connection portion 908 of the sling assembly 904, (B) the load 902, and (C) the sling hook-up point 912.

In accordance with an embodiment, the first connector 112 and the second connector 114 include an articulation assembly 116 (such as, a ball and socket assembly). The articulation assembly 116 is configured to provide articulation action (in use) between the sling tensioning assembly 102 and the sling assembly 904. The ball and articulation assembly 116 is configured to be operatively connected to distal ends of the sling tensioning assembly 102. The first connector 112 and the second connector 114 may include clamping devices having a quick-release device that is configured to release application of a clamping force to be applied by the clamping device, etc.

Referring to the embodiment as depicted in FIG. 8A and FIG. 8B, the connector assembly 108 includes a stitching material configured to stitch (fixedly connect) to the sling tensioning assembly 102 to the sling assembly 904 (that is, to the first sling connection portion and the second sling connection portion of the sling assembly 904). A clamp device 918 connects the sling assembly 904 to the load 902. The load 902 is depicted as a car, and the moving assembly 900 is depicted as a pick-up truck. The sling assembly 904 is fixedly attached to the car and the truck (as depicted in FIG. 8A). Referring to the embodiment as depicted in FIG. 8B, the moving assembly 900 (depicted as a truck) is moved in such a way that the moving assembly 900 pulls the sling assembly 904 tightly.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for use with a moving assembly being configured to move a load via a sling assembly being configured to be operatively connect to the load with the sling assembly having a first sling connection portion and a second sling connection portion being spaced apart from the first sling connection portion, the apparatus comprising:
a sling tensioning assembly having a first connection portion and also having a second connection portion being spaced apart from the first connection portion, and the sling tensioning assembly being configured, in use, to remove the slack from the sling assembly; and
a connector assembly being configured to:
connect the first connection portion of the sling tensioning assembly to the first sling connection portion of the sling assembly; and
connect the second connection portion of the sling tensioning assembly to any one of the second sling connection portion of the sling assembly and the load.

2. The apparatus of claim 1, wherein:
the sling tensioning assembly includes:
an elastically deformable member.

3. The apparatus of claim 1, wherein:
the moving assembly is configured to move the load once the moving assembly is operatively coupled to the load, and the moving assembly is operated to do just so; and
the moving assembly is configured to support the load while moving the load above a working surface.

4. The apparatus of claim 1, wherein:
the moving assembly includes a movable-node point being configured to move the sling assembly.

5. The apparatus of claim 4, wherein:
the load includes a sling hook-up point located at a position in which the sling assembly is to make an operative attachment to the load; and
the sling assembly is configured to extend from the load to the movable-node point of the moving assembly;
the sling assembly is configured to be operatively connectable to the sling hook-up point of the load and to the movable-node point of the moving assembly; and
the moving assembly is configured, in operation, to move the load via the sling assembly.

6. The apparatus of claim 1, wherein:
the sling tensioning assembly, in use, reduces formation of potential pinch points along the sling assembly.

7. The apparatus of claim 1, wherein:
the sling tensioning assembly is operatively attached to the sling assembly at each branch of the sling assembly that is operatively connected to the load.

8. The apparatus of claim 1, wherein:
the sling tensioning assembly, once installed, is configured to remove, at least in part, slack from the sling assembly.

9. The apparatus of claim 1, wherein:
the sling tensioning assembly, once installed, is configured to remove, at least in part, slack from the sling assembly before any one of the sling assembly and the load is moved relative to a working surface.

10. The apparatus of claim 1, wherein:
the sling tensioning assembly, once installed, is configured to lengthen, at least in part, once any one of the sling assembly and the load is moved relative to a working surface.

11. The apparatus of claim 1, wherein:
the sling tensioning assembly is installed to the sling assembly at spaced apart sling positions located on the sling assembly.

12. The apparatus of claim 1, wherein:
the sling tensioning assembly is installed to a sling position on the sling assembly and a sling hook-up point of the load.

13. The apparatus of claim 1, wherein:
a sling hook-up point is operatively attached to the load; and
the sling hook-up point is configured to be attachable to the sling assembly.

14. The apparatus of claim 1, wherein:
one end of the sling tensioning assembly is attached proximate to a sling hook-up point; and
another end of the sling tensioning assembly is attached at a position that is spaced apart from the sling hook-up point and closer to a movable-node point.

15. The apparatus of claim 14, wherein:
the sling hook-up point includes any one of a lug assembly and a shackle assembly;
the lug assembly is configured to be affixed to the load; and
the shackle assembly is configured to couple the lug assembly to an end section of the sling assembly.

16. The apparatus of claim 1, wherein:
the sling tensioning assembly includes:
an elastically deformable member including a bungee cord.

17. The apparatus of claim 1, wherein:
the connector assembly includes:
a first connector configured to be connectable to the first sling connection portion of the sling assembly; and
a second connector configured to be connectable to any one of:
the second sling connection portion of the sling assembly;
the load; and
a sling hook-up point.

18. The apparatus of claim 17, wherein:
the first connector and the second connector include:
an articulation assembly being configured to provide articulation action, in use, between the sling tensioning assembly and the sling assembly; and
the articulation assembly being configured to be operatively connected to distal ends of the sling tensioning assembly.

19. The apparatus of claim 17, wherein:
the connector assembly is configured to fixedly connect the sling tensioning assembly to the sling assembly.

20. An apparatus for a load, the apparatus comprising:
a sling assembly being operatively connectable to the load with the sling assembly having a first sling connection portion and a second sling connection portion being spaced apart from the first sling connection portion;
a moving assembly being configured to move the load via the sling assembly;
a sling tensioning assembly having a first connection portion and also having a second connection portion being spaced apart from the first connection portion; and
a connector assembly being configured to:
connect the first connection portion of the sling tensioning assembly to the first sling connection portion of the sling assembly; and
connect the second connection portion of the sling tensioning assembly to any one of the second sling connection portion of the sling assembly and the load.
